(19) United States
(12) Patent Application Publication
(10) Pub. No.: US 2007/0105677 A1
(43) Pub. Date: May 10, 2007

(54) Fixing belt

(75) Inventors: Yoshinari Takayama, Ibaraki-shi (JP); Tokio Fujita, Ibaraki-shi (JP); Tomoyuki Kasagi, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION

(21) Appl. No.: 11/642,529

(22) Filed: Dec. 21, 2006

Related U.S. Application Data
(62) Division of application No. 10/797,063, filed on Mar. 11, 2004.

(30) Foreign Application Priority Data
Mar. 12, 2003 (JP) P. 2003-066876

(51) Int. Cl. F16G 1/00; F16G 9/00

(52) U.S. Cl. 474/237; 474/264

(57) ABSTRACT

A high-strength polyimide belt, specifically, a fixing belt which, for example, has the given strength, heat resistance, rigidity, and flexibility necessary for conveying a receiving material while pressing and heating unfixed toner images, and which is excellent in functions such as belt lubricity, toner fixability, and toner releasability. The fixing belt comprises a tubular object made of a polyimide resin and at least one functional layer superposed thereon, wherein the tubular object is molded by applying a polyimide precursor to a tubular mold, defoaming the precursor by centrifugal force, and then converting the precursor into an imide. In this belt, the thickness of the tubular polyimide resin object and functional layer or the buckling strength and tear strength of the belt preferably are within respective given ranges.

### FIELD OF THE INVENTION

The present invention relates to a fixing belt for use in, for example, electrophotographic image-forming apparatus. The fixing belt is especially useful as a fixing belt for color image formation.

### DESCRIPTION OF THE RELATED ART

Seamless tubular objects made of a polyimide have hitherto been used as fixing-belt bases for electrophotographic image-forming apparatus such as, e.g., copiers, laser beam printers, and facsimile telegraphs. In particular, since receiving materials are conveyed while pressing and heating unfixed toner images on fixing belts, the fixing belts are coming to be increasingly required to have: strength which enables the belts to withstand stretching between rolls; heat resistance which enables the belts to withstand the heating by rolls; rigidity which enables the belts not to buckle when pushed at an end part thereof for positional correction; and flexibility necessary for separating excess toners.

As a technique for producing a thin high-strength polyimide belt which meets those requirements, a process for belt production has been proposed which comprises coating a cylindrical mold with a poly(amic acid) solution as a polyimide precursor by dip coating, subsequently causing an outer die having a given inner diameter to fall freely around the cylindrical mold to regulate the coating film, and then heating and curing the poly(amic acid) solution layer applied (see, for example, JP-A-7-186162).

A composite tubular object for use as a fixing belt has also been proposed which comprises a tubular polyimide resin object and a fluororesin release layer superposed on the peripheral surface thereof for the purpose of improving toner releasability from the belt surface (see, for example, JP-A-7-186162 or JP-A-3-130149). Furthermore, a composite tubular object, for attaining higher image quality in color image fixing is known which comprises a tubular polyimide resin object and, superposed on the peripheral surface thereof, a rubbery elastic layer such as a silicone rubber or fluororubber layer (see, for example, JP-A-5-15463).

However, the dip coating using an outer die disclosed in patent document 1 has had a problem that since the coating film cannot be subjected to centrifugal defoaming or leveling, the films which can be formed are limited to thin films and the fixing belt hence suffers buckling or edge tearing.

Furthermore, with the recent trend toward higher image quality in copied images, there is a growing desire for an increase in the thickness of the fluororesin release layer or rubbery elastic layer. Despite this, it is difficult to attain both defoaming and thickness increase in any of the related-art processes for producing a composite tubular object. There has hence been a problem that when the tubular object is set in a copier and this copier is operated, the tubular object may deform or buckle.

### SUMMARY OF THE INVENTION

Accordingly, an object of the invention is to provide a fixing belt which has the given strength, heat resistance, rigidity, and flexibility necessary for conveying a receiving material while pressing and heating unfixed toner images, and which is excellent in functions such as belt lubricity, toner fixability, and toner releasability.

The present inventors made intensive investigations on polyimide belts in order to accomplish that object. As a result, they have found that the requirements shown above can be satisfied by producing a tubular polyimide resin object by a specific process. The invention has been completed based on this finding.

The invention provides a fixing belt comprising a tubular object made of a polyimide resin and at least one functional layer superposed thereon, wherein the tubular object is molded by applying a polyimide precursor to a tubular mold, defoaming the precursor by centrifugal force, and then converting the precursor into an imide. Use of the belt produced by the process can provide a fixing belt in which the tubular object is free from deformation, buckling or the like, even when the layer superposed has an increased thickness.

In the invention, the functional layer preferably is a rubbery elastic layer or a fluororesin release layer. Use of the belt produced by this process can provide a fixing belt in which the tubular object is free from deformation, buckling, or the like while securing excellent functions such as belt lubricity, toner fixability, and toner releasability.

In this fixing belt, the tubular polyimide resin object preferably has a thickness of 70-200 μm and the functional layer superposed preferably has a thickness of 5-500 μm. This belt retains rigidity and is prevented from buckling. In addition, toners on the belt can be smoothly released due to a proper curvature radius.

The belt preferably has a buckling strength of 40 N or higher and a tear strength of 0.2 N or higher. Thus, a practical belt which is prevented from buckling or damaging when stretched with conveying and other rollers can be provided.

### DETAILED DESCRIPTION OF THE INVENTION

The invention present will be explained in detail below.

The fixing belt of the invention comprises a tubular object made of a polyimide resin and at least one functional layer superposed thereon, and is characterized in that the tubular object is molded by applying a polyimide precursor to a tubular mold, defoaming the precursor by centrifugal force, and then converting the precursor into an imide. Fixing belts are often produced such that the superposed layer having any of various functions (hereafter referred to as “functional layer”), such as a rubbery elastic layer or a fluororesin release layer, has an increased or reduced thickness according to applications. The invention is based on the finding that the belt produced by the process described above has a property such that even when the thickness of the functional layer is changed, the tubular object does not suffer deformation, buckling or the like. When the fixing belt of the invention is used as the fixing belt of an electrophotographic image-forming apparatus, release offset does not occur and long-lasting fixability is obtained.

Specifically, the fixing belt of the invention can be produced according to the following procedure.

(1) A poly(amic acid) solution is prepared. The solution preparation will be described later.

(2) While a cylindrical mold is rotated, the poly(amic acid) solution is applied to the inner surface of the cylindrical mold. For the application, a method may be used in which the poly(amic acid) solution is applied to the inner surface of the mold with a dispenser or the like and this coating layer is finished with, e.g., a rigid ball so as to have a given thickness.

(3) The coating layer is leveled and defoamed by the centrifugal method to form a resin layer comprising the poly(amic acid) on the inner surface of the mold.

(4) The poly(amic acid) solution is heated or subjected to solvent extraction, etc., to thereby solidify or cure the resin layer.

(5) The resin layer is further heated at high temperature to convert the resin into an imide, thereby obtaining a tubular object made of a polyimide resin.

The procedure described above is one embodiment of the invention, and addition or modification of steps are possible. For example, with respect to application methods, a method in which a bullet-form or spherical object is caused to run for application can be used. It is also possible to use a method which comprises peeling the resin layer from the mold prior to conversion into an imide, inserting a cylindrical member thereinto, and then conducting imide formation.

It is preferred in the invention that the functional layer be a rubbery elastic layer or a fluororesin release layer. Among various functional layers, the rubbery elastic layer, which is suitable for attaining higher image quality in color image fixing, and the fluororesin release layer, which is suitable for attaining improved toner releasability from the belt surface, are especially required to have a larger thickness as described above. Application of the process described above is hence highly effective. According to the invention, a fixing belt can be provided in which the tubular object is free from deformation, buckling, or the like while securing excellent functions such as belt lubricity and toner fixability or releasability. The rubbery elastic layer or fluororesin release layer will be explained later in detail.

It is preferred that the thickness of the tubular object be 70-200 μm and the thickness of the functional layer be 5-500 μm. Buckling strength is influenced by the modulus of elasticity and thickness of the polyimide and by the diameter of the belt. Of these factors, the thickness of the tubular polyimide resin object is most influential. Thickness of the tubular polyimide resin object smaller than 70 μm is undesirable because the rigidity of edge parts of such a thin belt is insufficient for the load to be imposed for positional correction and the belt is hence apt to buckle. Thickness thereof exceeding 200 μm is undesirable because such a thick belt has an increased curvature radius at the separation roll which is one of the belt-stretching rolls and, hence, toners on the belt are not sufficiently released.

On the other hand, thickness of the functional layer smaller than 5 μm is undesirable because there is a possibility that such a thin layer might function insufficiently and because buckling is apt to occur. Thickness thereof exceeding 500 μm is undesirable because the belt comes to have an increased curvature radius and, hence, toners on the belt are not sufficiently released as in the case described above. Namely, by thus regulating the thickness of the tubular polyimide resin object and the functional layer, not only belt rigidity can be secured to prevent buckling but also a proper curvature radius can be obtained to enable toners on the belt to be released smoothly. Values of thickness were determined by measuring the thickness at several points and averaging the found values.

The belt preferably has a buckling strength of 40 N or higher and a tear strength of 0.2 N or higher. Where the tear strength thereof is lower than 0.2 N, this belt cannot be put to practical use because it is damaged in an early stage. Where the buckling strength of the belt is lower than 40 N, it is difficult to prevent this belt from buckling when stretched with rollers including a conveying roller. This belt cannot hence be put to practical use. The belt having strength within the ranges shown above can be prevented from buckling or damaging when stretched with rollers including a conveying roller and can function as a practical fixing belt. Values of buckling strength and tear strength herein mean values obtained through measurements by the methods described in Measurement Methods which will be given later.

The polyimide resin and functional layer used in the invention will be explained in detail below.

The poly(amic acid) to be used as a precursor for the polyimide resin in the invention can be the conventional poly(amic acid). It is, however, preferred to use a poly(amic acid) solution obtained by polymerizing an acid dianhydride with a diamine in a solvent. Preferred examples of the acid dianhydride include pyromellitic dianhydride, 3,3′,4,4′-benzophenonetetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, and 1,4,5,8-naphthalenetetracarboxylic dianhydride.

Examples of the diamine include 4,4′-diaminodiphenyl ether, 4,4′-diaminodiphenylmethane, 3,3′-diaminodiphenylmethane, 3,3′-dichlorobenzidine, 4,4′-diaminodiphenyl sulfide, 3,3′-diaminodiphenyl sulfone, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenyl sulfone, 4,4′-diaminodiphenyl sulfide, and 4,4′-diaminodiphenylpropane.

The solvent used in polymerizing the acid anhydride with the diamine can be an appropriate one. However, it is preferred to use a polar solvent from the standpoints of solubility, etc. Examples of the solvent include N,N-dimethylformamide, N,N-dimethylacetamide, N,N-diethylformamide, N,N-diethylacetamide, N,N-dimethylmethoxyacetamide, dimethyl sulfoxide, hexamethylphosphortriamide, N-methyl-2-pyrrolidone, pyridine, tetramethylenesulfone, and dimethyltetramethylenesulfone. These may be used alone or in combination of two or more thereof. Such organic polar solvents may be used as a mixture with one or more of phenols (such as cresol, phenol or xylenol), benzonitrile, dioxane, butyrolactone, xylene, cyclohexane, hexane, benzene, toluene, and the like.

By reacting the acid anhydride (a) with the diamine (b) in an organic polar solvent, a poly(amic acid) solution is obtained. Although the monomer concentration in this reaction (concentration of (a)+(b) in the solvent) is determined according to various conditions, it is preferably 5-30% by weight. The reaction temperature is regulated to preferably 80° C. or lower, and more preferably 5-50° C. The reaction period is preferably 0.5-10 hours.

The viscosity of the poly(amic acid) solution applied is about 10-10,000 P (poise), preferably about 50-5,000 P (Brookfield viscometer, 23° C.). Viscosity thereof lower than 10 P is undesirable because sagging and coating layer cissing are apt to occur, making it difficult to obtain evenness of coating film thickness. On the other hand, viscosity thereof exceeding 10,000 P is undesirable because application at high pressure is necessary for ejection and the leveling effect of centrifugal molding is difficult to produce.

In the invention, a filler such as surfactants, inorganic particles, inorganic oxides, or metal oxides can be suitably incorporated into the tubular polyimide resin object in order to impart desired functions such as thermal conductivity, electrical conductivity, antistatic properties, semiconductivity, and wearing resistance. Although the amount of the filler added is determined according to various conditions, the amount is 1-60% by weight, and preferably 5-50% by weight. Filler amount smaller than the lower limit is undesirable because desired properties are difficult to impart. On the other hand, filler amount larger than the upper limit is undesirable because the tubular polyimide resin object becomes brittle and hence has insufficient mechanical strength. There are cases where some kinds of fillers reduce the surface wettability of the molded tubular polyimide resin object depending on the addition amount thereof. It is therefore preferred to select one or more fillers such that the contact angle between the surface of the tubular object and water becomes 90° or smaller. Contact angle exceeding 90° is undesirable because application of a primer serving as an adhesive between the polyimide layer and a rubbery elastic layer superposed thereon is apt to result in cissing or spots and, hence, the fixing belt obtained has a reduced strength of adhesion to the rubbery elastic layer.

The speed of the peripheral-direction mold revolution conducted for centrifugal molding is preferably 100-5,000 rpm, although it varies depending on the diameter of the mold, viscosity of the poly(amic acid) solution, and state of the solution applied. Revolutional speeds thereof lower than 100 rpm are undesirable because the effect of leveling and defoaming the coating film by centrifugal force is difficult to obtain. Revolutional speeds exceeding 5,000 rpm are undesirable because an increased mechanical load causes vibrations to make the mold eccentric, resulting in uneven coating thickness in the mold length direction.

The conversion into an imide after centrifugal molding may be accomplished by heating the mold to a temperature not lower than the imide conversion temperature to form a tubular polyimide resin object as described above. Alternatively, a method may be used which comprises heating the poly(amic acid) solution in the mold to such a degree that the solution solidifies, taking the resulting tubular object out of the mold, putting this tubular object on a metallic pipe, and then converting the poly(amic acid) into an imide.

Examples of the material of the rubbery elastic layer superposed on the tubular polyimide resin object include silicone rubbers and fluororubbers. Fillers such as silica and red iron oxide can be added to these rubbers as in the case of the polyimide.

On the other hand, the material of the fluororesin release layer is not particularly limited as long as it contains fluorine atoms in the molecule. Examples of the material include polytetrafluoroethylene (PTFE) and modifications thereof, tetrafluoroethylene/perfluoroalkyl vinyl ether copolymers (PFA), tetrafluoroethylene/ethylene copolymers (ETFE), tetrafluoroethylene/hexafluoropropylene copolymers (FEP), tetrafluoroethylene/vinylidene fluoride copolymers (TFE/VdF), tetrafluoroethylene/hexafluoropropylene/perfluoroalkyl vinyl ether copolymers (EPA), polychlorotrifluoroethylene (PCTFE), chlorotrifluoroethylene/ethylene copolymers (ECTFE), chlorotrifluoroethylene/vinylidene fluoride copolymers (CTFE/VdF), poly(vinylidene fluoride) (PVdF), and poly(vinyl fluoride) (PVF). Preferred are PTFE, PFA, and mixtures of these from the standpoints of wearing resistance, toner releasability, and heat resistance. In the case of adding a filler, the amount thereof is preferably 0.1-50 wt %. Where the amount thereof is smaller than 0.1 wt %, the function of the filler is not sufficiently exhibited. Where the amount thereof exceeds 50 wt %, the effects attributable to fluorine, such as sliding properties and releasability, cannot be sufficiently exhibited.

Examples of methods for superposing a rubbery elastic layer and a fluororesin release layer on the tubular polyimide resin object include spray coating, dipping, and dispenser coating. For the layer superposition, a process may be used in which after a tubular polyimide resin object is molded, a rubbery elastic layer and a fluororesin release layer are superposed on the outer side of the object. Alternatively, a process may be used which comprises superposing a fluororesin release layer, a rubbery elastic layer, and a polyimide in this order on the inner surface of a mold to form a belt and then taking the belt out of the mold. Such a process can freely be selected according to the dimensional accuracy and properties of the belt produced and the molding cost. In superposing a fluororesin release layer, a primer may be applied as an interlayer between the release layer and the rubbery elastic layer in order to enhance adhesion to the rubbery elastic layer. Furthermore, a fluororesin release layer may be superposed by putting a tubular fluororesin on the rubbery elastic layer and then heating the fluororesin to shrink it.

The present invention is described in more detail by reference to the following Examples, but it should be understood that the invention is not construed as being limited thereto. In the following Examples and Comparative Examples, properties were evaluated by the following methods.

Measuring Methods

(1) Tearing Test

Measurement was made by a method in accordance with JIS K7128. In this test, the measurement was made by the Trouser tear method.

Buckling Test

Measurement was made by a method in accordance with JIS K7181. In this test, a sample piece having a length of 50 mm was examined with Tensilon (manufactured by Orientec Co.) at a compression rate of 10 mm/min.

Conditions for those measurements are shown in the Table below.

TABLE

| | (unit) | Tear strength | Buckling strength |
|---|---|---|---|
| Test speed | mm/min | 20 | 10 |
| Chuck-to-chuck | mm | 75 | ≧50 |
| distance | | | |
| Load cell | N | 50 | 2500 |
| Range | % | 4 | 10 |
| Full scale | N | 2 | 250 |
| Chart speed | mm/min | 20 | 100 |
| Test piece | mm | width 25/25 | height 50 |

### EXAMPLE 1

3,3′,4,4′-Biphenyltetracarboxylic dianhydride as an acid ingredient and a nearly equimolar amount of p-phenylenediamine as an amine ingredient were dissolved in N-methyl-2-pyrrolidone (NMP) (monomner concentration: 20% by weight). In a nitrogen atmosphere, the reaction mixture was reacted at room temperature with stirring and then stirred while heating it to 70° C. Thus, a poly(amic acid) solution having a viscosity, as measured at 23° C. with a Brookfield viscometer, of 2,000 P was prepared. A rectangular dice-form dispenser was fixed, and a cylindrical mold having a length of 900 mm and a diameter of 68 mm was moved, while being rotated, so that the poly(amic acid) solution was supplied to the cylindrical-mold inner surface, ranging from one end to the other end of the mold, and was spirally applied to the inner surface of the cylindrical mold (lap amount: 1 mm; gap amount: 0.7 mm). This mold was rotated as it was at 3,000 rpm for 3 minutes to thereby level the surface irregularities of the lapped areas of the coating film. Thus, an even coating film surface was obtained. The mold was heated stepwise to 220° C., while being rotated at 60 rpm, to remove the solvent. The resulting belt base which had not been converted to an imide was peeled from the cylindrical mold, put on an aluminum pipe, and then heated at 410° C. for 20 minutes to convert the polymer into an imide. The tubular polyimide resin object obtained had a length of 880 mm, a diameter of 68 mm, and a thickness of 75 μm.

A methyl silicone rubber (DX35-2083, manufactured by Dow Corning Toray Co., Ltd.) was applied to the tubular polyimide resin object by spray coating and then heated to form a 200 μm elastic layer. This silicone rubber was coated with a primer (PRM-027-3, manufactured by Du Pont-Mitsui Fluorochemicals Co., Ltd.) and an FEP dispersion coating material (ENA-020-45, manufactured by Du Pont-Mitsui Fluorochemicals Co., Ltd.) by spray coating. The resulting two coating layers were heated to form release layers having a thickness of 10-20 μm, respectively. Thus, a fixing belt was produced. This fixing belt had a tear strength of 0.45 N and a buckling strength of 120 N.

This fixing belt was stretched with an aluminum heating roll coated with a silicone rubber and having a diameter of 40 mm and an aluminum separation roll coated with PFA and having a diameter of 20 mm. An aluminum pressure roll coated with a silicone rubber and having a diameter of 40 mm was pressed, from the back side at a pressure of 0.2 MPa, against that part of the fixing belt which was in contact with the heating roll to thereby regulate the nip width to 10 mm. The temperature of the heating roll and the linear speed of the fixing belt were regulated to 170° C. and 120 mm/sec, respectively, and sheets of recording paper were caused to run so that the toner side faced the fixing belt.

As a result, release offset did not occur after toner fixing. Even after 100,000 sheets printing, the belt was free from buckling, edge damage, and delamination.

### EXAMPLE 2

3,3′,4,4′-Biphenyltetracarboxylic dianhydride as an acid ingredient and a nearly equimolar amount of p-phenylenediamine as an amine ingredient were dissolved in N-methyl-2-pyrrolidone (NMP) (monomer concentration: 20% by weight). In a nitrogen atmosphere, the reaction mixture was reacted at room temperature with stirring and then stirred while heating it to 70° C. Thus, a poly(amic acid) solution having a viscosity, as measured at 23° C. with a Brookfield viscometer, of 2,000 P was prepared. A rectangular dice-form dispenser was fixed, and a cylindrical mold having a length of 900 mm and a diameter of 30 mm was moved, while being rotated, so that the poly(amic acid) solution was supplied to the cylindrical-mold inner surface, ranging from one end to the other end of the mold, and was spirally applied to the inner surface of the cylindrical mold (lap amount: 1 mm; gap amount: 0.7 mm). This mold was rotated as it was at 3,000 rpm for 10 minutes to thereby level the surface irregularities of the lapped areas of the coating film. Thus, an even coating film surface was obtained. The mold was heated stepwise to 220° C., while being rotated at 60 rpm, to remove the solvent. The resultant belt base which had not been converted to an imide was peeled from the cylindrical mold. A polyimide primer (K001-02, manufactured by Du Pont-Mitsui Co., Ltd.) was applied to the belt by spray coating in a thickness of 1 μm on a dry basis. A 35% dispersion (511CL, manufactured by Du Pont-Mitsui, Co., Ltd.) prepared by dispersing PFA having a melt flow rate of 1.7 g/10 min (ASTM D3307) in water was further applied thereon by spray coating. This coated belt was put on an aluminum pipe and heated at 410° C. for 20 minutes to thereby convert the poly(amic acid) into an imide and melt the PFA. The fixing belt thus obtained had a length of 880 mm and a diameter of 30 mm. The thickness of the tubular polyimide resin object was 80 μm and that of the PFA layer was 30 μm. This fixing belt had a tear strength of 0.5 N and a buckling strength of 75 N.

This fixing belt was contacted with an aluminum heating roll coated with a silicone rubber and having a diameter of 40 mm, and a pressure of 0.2 MPa was applied thereto to thereby regulate the nip width to 5 mm. The temperature of the heating roll and the linear speed of the fixing belt were regulated to 190° C. and 120 mm/sec, respectively, and sheets of recording paper were caused to run so that the toner side faced the fixing belt.

As a result, release offset did not occur after toner fixing. Even after 100,000 sheets printing, the belt was free from buckling, edge damage, and delamination.

### COMPARATIVE EXAMPLE 1

The same procedure as in Example 2 was conducted, except that the rotational molding was conducted under the conditions of 50 rpm and 10 minutes. The tubular polyimide resin object molded was undulating. The tubular polyimide resin object had an average thickness of 80 μm and a minimum thickness of 65 μm. This fixing belt had a tear strength of 0.15 N and a buckling strength of 50 N.

This fixing belt was mounted in a fixing part and sheets of recording paper were caused to run, in the same manner as described above. As a result, the belt edges began to damage in 3,000 sheets printing and the belt buckled in 20,000 sheets printing.

### COMPARATIVE EXAMPLE 2

The same procedure as in Example 2 was conducted, except that a PTFE powder (KTL-8, manufactured by K.K. Kitamura) was added to the poly(amic acid) solution in an amount of 14 wt % based on the solid polyimide and evenly dispersed therein by stirring. The fixing belt obtained had a tear strength of 0.1 N and a buckling strength of 20 N.

This fixing belt was mounted in a fixing part and sheets of recording paper were caused to run, in the same manner as described above. As a result, the belt edges began to damage in 1,000 sheets printing and the belt buckled in 10,000 sheets printing.

As described above, the belt of the invention comprises a tubular polyimide resin object produced by a specific process and a functional layer superposed thereon. Due to this constitution, the fixing belt provided by the invention is free from the deformation or buckling of the tubular object even when the layer superposed has an increased thickness.

Especially when the functional layer is a rubbery elastic layer or fluororesin release layer, that process can be effectively utilized to provide a fixing belt in which the tubular object is free from deformation, buckling, or the like while securing excellent functions such as belt lubricity, toner fixability, and toner releasability.

When the thicknesses of the tubular polyimide resin object and functional layer in this fixing belt are regulated so as to be within the respective given ranges, then the belt can retain rigidity and is prevented from buckling. In addition, toners on this belt can be smoothly released due to a proper curvature radius.

Further, by regulating the belt so as to have given values of buckling strength and tear strength, a practical fixing belt which is prevented from buckling or damaging when stretched with conveying and other rollers can be provided.

It should further be apparent to those skilled in the art that various changes in form and detail of the invention as shown and described above may be made. It is intended that such changes be included within the spirit and scope of the claims appended hereto.

This application is based on Japanese Patent Application No. 2003-66876 filed Mar. 12, 2003, the disclosure of which is incorporated herein by reference in its entirety.

1-4. (canceled)

5. A process of molding a tubular object comprising applying a polyimide precursor to a tubular mold, defoaming the precursor by centrifugal force, and converting the precursor into an imide.

6. A process of producing a fixing belt, comprising applying a polyimide precursor to a tubular mold, defoaming the precursor by centrifugal force, converting the precursor into an imide, and superposing a functional layer onto the tubular object.

7. The process according to claim 6, wherein the functional layer is a rubbery elastic layer or a fluororesin release layer.

8. The process according to claim 6, wherein the tubular object has a thickness of 70-200 μm and the functional layer has a thickness of 5 to 500 μm.

9. The process according to claim 6, wherein the fixing belt has a buckling strength of 40 N or higher and a tear strength of 0.2 N or higher.
